(19) United States
(12) Patent Application Publication
(10) Pub. No.: US 2011/0106598 A1
(43) Pub. Date: May 5, 2011

(54) Surfacing Digital Coupons to Customers

(76) Inventors: Monica Theresa McCann, Seattle, WA (US); William W. Allocca, Bellevue, WA (US); Brandon R. I. Chang, Seattle, WA (US); Henry Robert Nickerson, Seattle, WA (US); Mark S. Gulbrandsen, Seattle, WA (US); Douglas J. Herrington, Seattle, WA (US); Dilip S. Kumar, Seattle, WA (US); James J. Shimada, Seattle, WA (US); Paul D. DeMarco, Seattle, WA (US)

(21) Appl. No.: 12/608,679

(22) Filed: Oct. 29, 2009

(51) Int. Cl. G06Q 30/00

(52) U.S. Cl. 705/14.13; 705/14.39

(57) ABSTRACT

Various systems, methods, and other embodiments are described relating to the selection of digital coupons for display in network pages. In one embodiment, a plurality of coupon campaigns are maintained in a computing device for a plurality of entities in association with an operation of an electronic commerce system employed to sell a plurality of items over a network. Each of the coupon campaigns comprises at least one digital coupon to be applied to a purchase of at least one of the items. A network page is generated in the electronic commerce system to be rendered on a client. The network page is generated in association with the operation of the electronic commerce system. A subset of the digital coupons is determined to be included in the network page to present to a user.

### BACKGROUND

Merchants who sell products over the Internet may wish to offer coupons to consumers in association with the online sale of goods. A problem can be presented in that implementing the many different coupons in association with the operation of a large online merchant can be burdensome and labor intensive. In addition, it may be the case that large numbers of coupons may relate to specific customers. This makes it more difficult to determine which coupons to surface for specific customers.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 is a drawing of a networked environment including various computing devices according to an embodiment of the present disclosure.

FIG. 2 is a drawing of one example of a network page rendered on a display device of a computing device such as a client in the networked environment of FIG. 1 according to an embodiment of the present disclosure.

FIG. 3 is a drawing of another example of a network page rendered on a display device of a computing device such as a client in the networked environment of FIG. 1 according to an embodiment of the present disclosure.

FIG. 4 is a flowchart that illustrates an example of functionality implemented in a computing device such as a server in the networked environment of FIG. 1 according to an embodiment of the present disclosure.

FIG. 5 is a schematic block diagram that illustrates one embodiment of a computing device such as a server in the networked environment of FIG. 1 according to an embodiment of the present disclosure.

### DETAILED DESCRIPTION

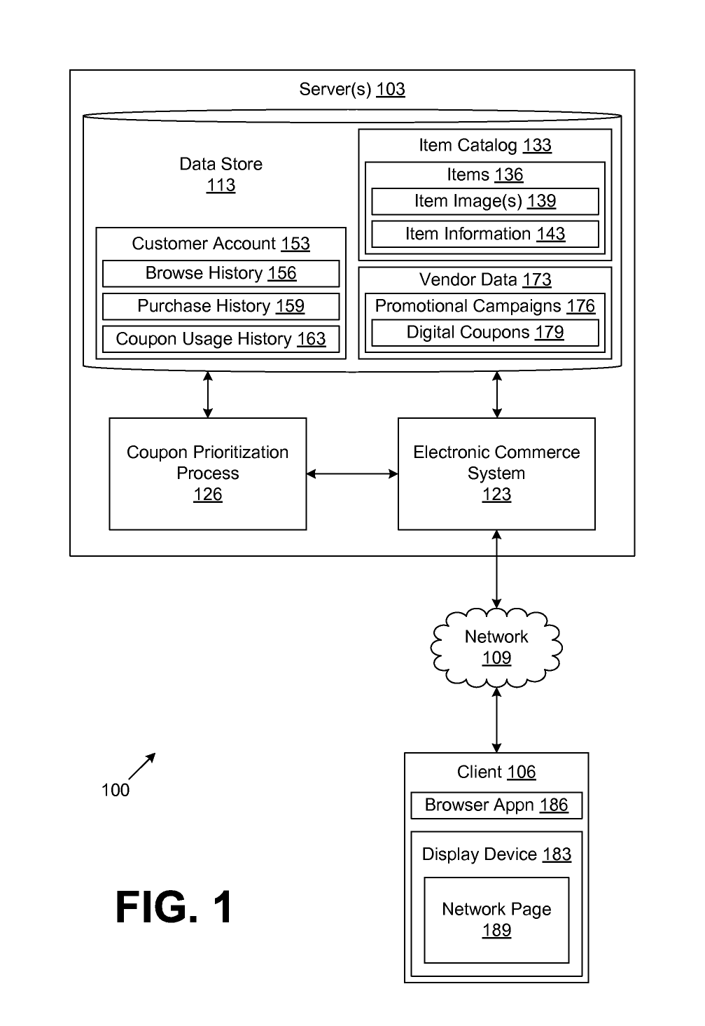

With reference to FIG. 1, the following relates to the implementation of coupons in a networked environment 100 in association with the activities of a merchant that sells goods and/or services online, for example, over the Internet. In the following discussion, first a description of the physical nature of the networked environment 100 is provided followed by a description of the operation of the same. More detailed discussion of various aspects is provided with respect to later figures.

The networked environment 100 depicted in FIG. 1 includes various computing devices such as, for example, a server 103, a client 106, and/or other computing devices that are coupled to a network 109. The network 109 may comprise, for example, the Internet, intranets, extranets, wide area networks (WANs), local area networks (LANs), wired networks, wireless networks, or other suitable networks, etc., or any combination of two or more such networks. For purposes of convenience, the server 103 and the client 106 are each referred to herein in the singular. However, it is understood that in one embodiment, the servers 103 may represent a plurality of servers, and the client 106 may represent a plurality of clients.

The server 103 comprises one example of a computing device that may be employed to execute various components as described herein. The server 103 may comprise, for example, a server computer or like system, and may represent multiple servers arranged, for example, in one or more server banks or other arrangements. Such servers may be located in a single installation or may be dispersed among many different geographical locations. To this end, the server 103 may be viewed as a server “cloud” that represents the computing capacity of multiple servers, etc.

Various applications and/or engines are executed in the server 103 according to various embodiments. Also, various data may be stored in a data store 113 that is accessible to the server 103. The data stored in the data store 113, for example, may be associated with the operation of the various applications and/or engines described below. The applications executed in the server 103 may include, for example, an electronic commerce system 123, a coupon prioritization process 126, and other applications not discussed in detail herein.

The electronic commerce system 123 is configured to conduct electronic commerce to facilitate the network presence of one or more online merchants. The electronic commerce system 123 may comprise may different applications, components, and/or systems implemented on a plurality of computing devices such as the server 103 that are located at one site, or are distributed among geographically diverse sites as can be appreciated.

The applications, components, and/or systems included in the electronic commerce system 123 provide for various functions such as maintaining and accessing an item catalog 133 in which is stored data describing a plurality of items 136 sold to customers by an online merchant. The data describing each of the items 136 may include item images 139 and item information 143. The items 136 sold through the electronic commerce system 123 may comprise, for example, goods and/or services.

The electronic commerce system 123 may also provide for various functions such as, for example, searching for items 136, generating network pages with search results or for other purposes, implementing the purchase of items 136, effecting payment for items 136 purchased, and other functions. In providing for the purchase of items 136, the electronic commerce system 123 may generate a plurality of different network pages such as web pages or other network content that is served up to various clients 106 controlled by customers. Such network pages may be static or created dynamically.

In addition, various customer accounts 153 may be maintained in the data store 113. Each customer account 153 may include customer data that describes the customer including payment addresses, delivery addresses, payment instruments, and other data used to consummate various commercial transactions. Also associated with each of the customer accounts 153 are a browse history 156, purchase history 159, coupon usage history 163, and potentially other data. In one embodiment, the coupon usage history 163 may actually be included as part of the purchase history 159 as can be appreciated.

In addition, vendor data 173 is stored in the data store 113 that describes information about various vendors such as manufacturers and other types of vendors that produce or otherwise provide items 136 that are sold through the electronic commerce system 123. In addition, an online merchant, for example, may operate the electronic commerce system 123. The vendor data 173 may include information about respective vendors including address and contact information, banking information, supply contract information, and other information not important for the purposes of this discussion that is needed to transact business with such vendors as can be appreciated. The vendor data 173 specifically includes data that describes various promotional campaigns 176 that are launched by vendors to provide greater incentives to their customers to purchase the items 136 they offer. Also, the promotional campaigns 176 may be offered by the online merchant that operates the electronic commerce system 123, or the online merchant may collaborate with vendors to provide offerings. Thus, were a vendor is discussed herein, it is understood that the online merchant may stand in the place of such a vendor for the purposes of the following discussion.

According to one embodiment, one or more digital coupons 179 are associated with each of the promotional campaigns 176 as will be described. As contemplated herein, a digital coupon 179 comprises a digital instrument that may be selected by a user that entitles the user to redeem a benefit in association with a purchase of one or more items 136. Such a benefit may comprise, for example, a discount off of a purchase price for one or more items 136, whether the discount is a fixed dollar amount or a percentage of the purchase price. The benefit may also comprise, for example, giveaways of additional items 136, free shipping for items 136, discounts (fixed or percent reduction) for items 136 related to items 136 purchased, or other benefits.

In addition, associated with one or more of the digital coupons 179 is data that indicates a degree to which a preference is to be applied to the digital coupons 179 based on payment by vendors for greater exposure for such digital coupons 179 as will be described. In one embodiment, vendors may pay for greater exposure based upon specific search terms used by customers who browse through items 136. For example, when a specific search term is entered that is directly relevant, a vendor may indicate a willingness to pay a higher fee to obtain a greater likelihood of exposure of a respective digital coupons 179.

The client 106 is representative of a plurality of client devices that may be coupled to the network 109. For example, the client 106 may comprise one of millions of clients 106 coupled to the Internet. The client 106 may comprise, for example, a processor-based system such as computer system. Such a computer system may be embodied in the form of a desktop computer, a laptop computer, a personal digital assistant, a cellular telephone, set-top box, music players, web pads, tablet computer systems, or other devices with like capability.

The client 106 may include, for example, various peripheral devices. In particular, the peripheral devices may include input devices such as, for example, a keyboard, keypad, touch pad, touch screen, microphone, scanner, mouse, joystick, or one or more push buttons, etc. The peripheral devices may also include a display device 183, indicator lights, speakers, etc. The display device 183 may comprise, for example, cathode ray tubes (CRTs), liquid crystal display (LCD) screens, gas plasma-based flat panel displays, LCD projectors, or other types of display devices, etc.

Executed within the client 106 are various applications including a browser application 186. The client browser application 186 is configured to interact with the electronic commerce system 123 and potentially other applications on the server 103 according to an appropriate protocol such as the Internet Protocol Suite comprising Transmission Control Protocol/Internet Protocol (TCP/IP) or other protocols. To this end, the browser application 186 may comprise, for example, a commercially available browser such as INTERNET EXPLORER® sold by Microsoft Corporation of Redmond, Wash., or MOZILLA FIREFOX® which is promulgated by Mozilla Corporation of Mountain View, Calif., or other type of browser. Alternatively, the browser application 186 may comprise some other application with like capability. When executed in the client 106, the browser application 186 is configured to render network pages 189 such as web pages and the like on the display device 183 and to perform other functions. Also, the browser application 186 may implement the execution of active portions of a network page 189 as can be appreciated.

Next, a brief discussion of the operation of the various components in the networked environment 100 is provided. To begin, the electronic commerce system 123 serves up various network pages 189 to the client 106 that are rendered by the browser application 186 on the display device 183. The network pages 189 served up by the electronic commerce system 123 to the client 106 accomplish various purposes as mentioned above.

The network pages 189 served up to the client 106 facilitate sales of items 136 through the electronic commerce system 123 as mentioned above. In some situations, the identity of a customer that uses the client 106 may be known to the electronic commerce system 123, thereby allowing the electronic commerce system 123 to associate the customer with one of the customer accounts 153. The identity of the customer may be determined, for example, based on cookies or other data that are stored in the client 106 in association with the browser application 186. Also, the customer may be required to log on to the electronic commerce system 123 in order make purchases by providing authentication information such as a username and password. In other situations, the user may be unknown to the electronic commerce system 123, having never purchased items 136 through the electronic commerce system 123 on a prior occasion.

From time to time, some of the network pages 189 generated by the electronic commerce system 123 during the course of interaction with a given customer may include a “coupon book” that comprises a listing of digital coupons 179 that a user may click upon or otherwise manipulate in order to redeem in association with the purchase of one or more items 136 through the electronic commerce system 123. Alternatively, digital coupons 179 may be displayed in network pages 189 without the use of a coupon book. At any given time, various ones of the digital coupons 179 stored in the data store 113 are active and may be applicable to the purchase of items 136. The digital coupons 179 may come and go as vendors submit promotional campaigns 176 with such digital coupons 179 having limited time duration to the server 103 to be employed in conjunction with the operation of the electronic commerce system 123.

When the electronic commerce system 123 is to create a network page 189 that includes a coupon book or other arrangement of coupons to be rendered to a user on the display device 183, the electronic commerce system 123 may request a listing of coupons from the coupon prioritization process 126. Such listing will provide the specific digital coupons 179 that are to be encoded as a portion of a network page 189 to be rendered on the display device 183 of the client 106.

Upon receiving the request, the coupon prioritization process 126 proceeds to obtain an initial pool of all of the digital coupons 179 to be considered for inclusion in a given network page 189 to be presented to the current customer. To this end, the request from the electronic commerce system 123 for the listing of digital coupons 179 may include the identity of the customer for which the current network page 189 is being generated. Also, a description of the content of the network page 189 to be generated may be included in the request. In identifying the initial pool of digital coupons 179 for consideration, the coupon prioritization process 126 may examine many different factors.

Such factors considered may include, for example, whether the digital coupons 179 are related to the content of the network page 189 being generated. Also, the browse history 156, purchase history 159, coupon usage history 163, and/or other information about the respective customer, if known, may be examined. In addition, collective historical data that relates to many, if not all, of the customers may be examined to identify relationships between respective pairs or groups of digital coupons 179 to identify affinities between two or more digital coupons 179. Such affinities are preferably those that result in an increased probability that a given digital coupon 179 should be presented to the customer as will be described.

Alternatively, in some cases the identity of the user of the client 106 may be unknown to the electronic commerce system 123. In such cases, the electronic commerce system 123 may try to determine any information about the unknown customer to the degree possible. In one embodiment, the electronic commerce system 123 may attempt to determine a geographical location of the customer based on the Internet Protocol (IP) address associated with the client 106. To this end, the electronic commerce system 123 may examine the progression of network pages 189 viewed by the customer to obtain their IP address and other information. Various techniques may be employed to determine a geographical location of the user based on their IP address and other information as described in U.S. patent application entitled “Mapping Attributes to Network Addresses” filed on Jun. 29, 2007 and assigned application Ser. No. 11/771,679, which is incorporated herein by reference in its entirety. The geographical location information known about the customer may be employed to determine which digital coupons 179 are relevant to be considered for inclusion in a given network page 189.

Once the initial pool of digital coupons 179 is identified, the coupon prioritization process 126 then proceeds to determine a score for each of the digital coupons 179 based on a plurality of factors. Such factors may be the same factors as were described above that were examined to determine whether a digital coupon 179 should be included in the initial pool as will be described in further detail below.

Thereafter, a predefined number of the digital coupons 179 having the highest ones of the scores may be selected to be included in the network page 189 generated by the electronic commerce system 123. Thereafter, the coupon prioritization process 126 sends the list of digital coupons 179 to be presented as part of the network page 189 to the requesting process of the electronic commerce system 123. In response, the electronic commerce system 123 encodes the respective digital coupons 179 as part of the network page 189 and serves the same up to the client 106 to be rendered by the browser application 186 on the display device 183.

As an alternative, it may be the case that some types of digital coupons 179 are automatically included in the list or subset of digital coupons 179 that are included in a network page 189. Such digital coupons 179 may bypass the scoring and ranking process mentioned above. Specifically, the coupon usage history 163 of a given customer may be examined to identify digital coupons 179 that have been redeemed by the customer in the past.

Also, the coupon prioritization process 126 may identify an affinity between a first digital coupon 179 that a user has previously redeemed and a second one of the digital coupons 179 stored in the data store 113. Such an affinity may be determined by identifying when a predefined percentage of customers that redeemed a first one of the digital coupons 179 that a user has previously redeemed have also redeemed the second one of the digital coupons 179. Such affinities may be deemed to be more predictive of whether a customer will redeem such digital coupons 179 in association with their interaction with the electronic commerce system 123. As such, such digital coupons 179 that are subject to an affinity as determined above may automatically be included in the list of digital coupons 179 sent back to the electronic commerce system 123 for inclusion in a network page 189 regardless of the scoring performed on the digital coupons 179 in the initial pool mentioned above.

In some situations, the initial pool of digital coupons 179 may not be identified, where one or two select factors are used to identify digital coupons 179 to include in a given network page 189. Such factors deemed to be the most relevant factors to a given situation may typically only identify a small number of digital coupons 179, thus bypassing the need to score digital coupons 179 to determine the ultimate subset of digital coupons 179 that should be included in a given network page 189.

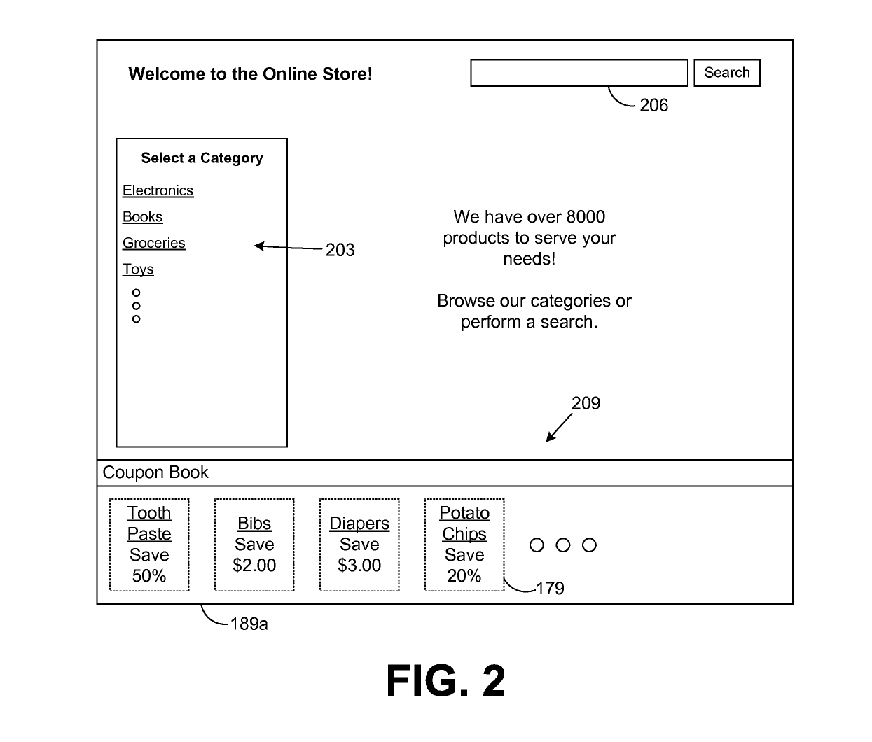

Referring then to FIG. 2, shown is one example of a network page 189, denoted herein as network page 189a, that may comprise, for example, a home page for an online merchant that sells their items 136 (FIG. 1) through the electronic commerce system 123 (FIG. 1). The network page 189a lists a number of categories 203 that may be selected by users as the upper level components of a taxonomy that may be navigated by a user to drill down to a group of items 136 listed in the item catalog 133 (FIG. 1) that they wish to purchase. Alternatively, the network page 189a includes a search text box 206 that allows users to enter a search query in an effort to identify one or more items 136 they wish to purchase.

The network page 189a also includes a coupon book 209 that lists a plurality of digital coupons 179. The digital coupons 179 presented in the coupon book 209 as part of the network page 189a are restricted to a subset of all of the digital coupons 179 that are stored in the data store 113 (FIG. 1). The digital coupons 179 are selected to be included within the subset of those presented in the network page 189a as they are deemed to be most likely to be redeemed by customers or because some other reason dictates that they be included in the network page 189a as will be described.

Once a customer clicks on or otherwise selects a digital coupon 179 while browsing various items 136, according to one embodiment, the electronic commerce system 123 tracks those digital coupons 179 selected by customers and applies the respective benefits offered by those digital coupons 179 at checkout when such items 136 are purchased. Alternatively, the redemption of digital coupons 179 may be implemented in some other manner.

In addition, it may be the case that at a given time, a vendor may have two or more digital coupons 179 active for use by the electronic commerce system 123. In one embodiment, a vendor may specify that only a single digital coupon 179 is to be presented for a given item 136 at a time to prevent a customer from being able to redeem multiple digital coupons 179 for the same item 136.

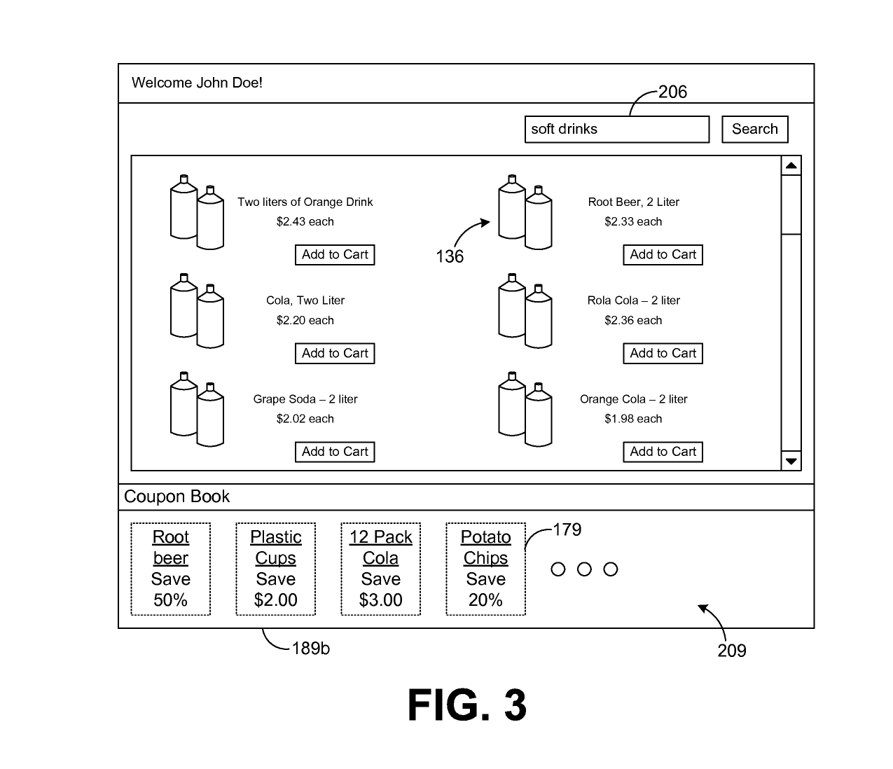

With reference to FIG. 3, shown is a second network page 189, denoted herein as network page 189b, that depicts yet another example of a coupon book 209 that lists a plurality of digital coupons 179 in association with the subject matter of the network page 189b. As shown, a search has been performed for “soft drinks” in the search text box 206. As a result, a listing of soft drink products is included in the network page 189b. In one embodiment, the digital coupons 179 selected to be presented in the network page 189b comprise those that have a relationship or affiliation with the content of the network page 189b such as the items 136 presented, or with the search terms used to find the items 136. In addition, the digital coupons 179 presented in the network page 189b may be identified based on other factors as will be described.

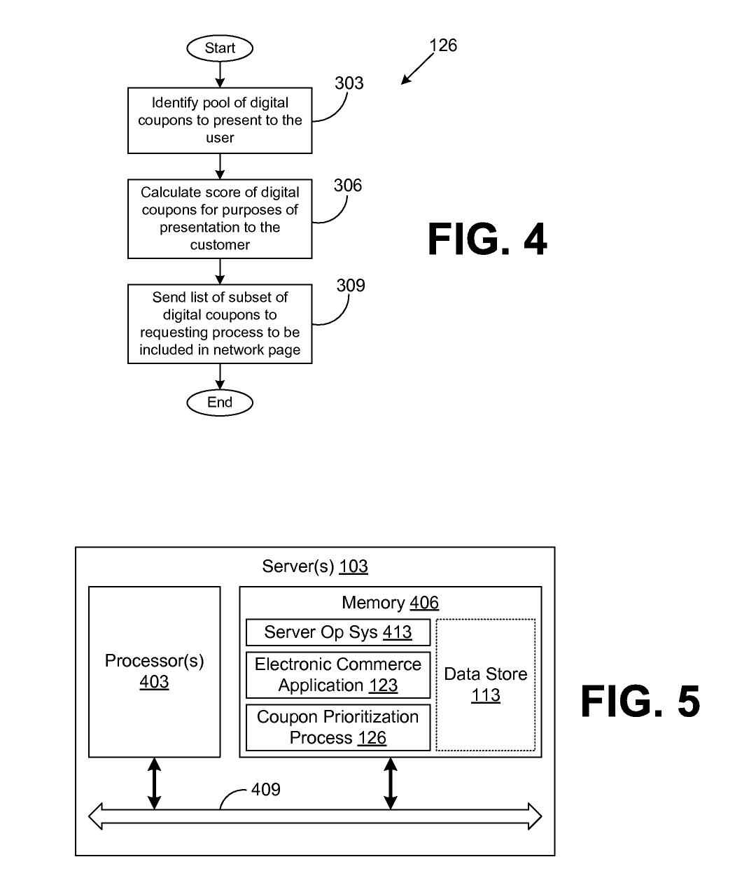

With reference to FIG. 4, shown is a flowchart that provides one example of various functionality of the coupon prioritization process 126 according to various embodiments. Alternatively, the flowchart of FIG. 4 may be viewed as depicting steps of a method implemented in the server 103 (FIG. 1). The functionality depicted in FIG. 4 is implemented each time the coupon prioritization process 126 is called upon by the electronic commerce system 123 (FIG. 1) to obtain a list of digital coupons 179 (FIG. 1) to include in a given network page 189 (FIG. 1) to be sent to a client 106 (FIG. 1) and rendered on a display device 183 (FIG. 1) by a browser application 186 (FIG. 1).

To begin, in box 303, the coupon prioritization process 126 identifies an initial pool of relevant digital coupons 179 to present to a customer. There may be several factors that are taken into account to determine whether a given digital coupon 179 is relevant for purposes of consideration as to whether such digital coupon 179 should be included in a network page 189. Factors requiring knowledge of the identity of the customer are generally considered when the identity of the customer is known as mentioned above.

Factors to consider may comprise, for example, demographics and other information known about a customer may be examined to determine which digital coupons 179 may be applicable to a given customer. For example, if the customer is a parent with young children, then digital coupons 179 may be selected that relate to items 136 that relate to children such as diapers, sippy cups, baby food, infant formula, and other items, etc.

Also, the various factors that may be considered is whether an affinity exists between a pair or group of digital coupons 179, where the respective user has previously selected or redeemed one of the digital coupons 179 in the pair or group. For example, the affinity between digital coupons 179 may be identified by identifying among several customer accounts 153 (FIG. 1) that a threshold number of customers who redeem a first digital coupon 179 also tend to redeem a given second digital coupon 179. An affinity may be recognized when the number of customers who exhibit such behavior has reached a threshold number of users or some other standard may be applied. Thus, any digital coupons 179 that have an affinity with other digital coupons 179 redeemed on a prior occasion by the customer as determined by the coupon usage history 163 (FIG. 1) associated with the customer may be deemed relevant for purposes of presentation to the customer.

Another factor involves whether increased exposure is to be given for digital coupons 179 for respective vendors who pay a fee for such treatment. Such vendors may pay a fee to increase the probability that one or more digital coupons 179 will be selected for inclusion in a given network page 189 generated by the electronic commerce system 123. Thus, for example, where other factors may not indicate a strong relationship or relevance to the generation of the current network page 189, it may be that enhanced exposure paid for by a respective vendor may cause such digital coupon 179 to be selected for inclusion in the network page 189 currently under construction.

Still other factors that may be considered in selecting digital coupons 179 for inclusion in a network page 189 currently under construction may include the conversion rates and/or impression rates associated with such digital coupons 179. For example, a digital coupon 179 that has an unusually high conversion rate indicates the popularity of such a digital coupon 179 relative to other digital coupons 179, thereby increasing the desirability of such digital coupon 179 for selection to include in the network page 189 under construction. As contemplated herein, the concept of “conversion” involves the user clicking on a given digital coupon 179 or otherwise taking such actions so as to redeem the digital coupon 179. Alternatively, the concept of conversion may include clicking on or otherwise manipulating a digital coupon 179 in order to learn more about it, etc. As such, conversion may include any action taken with respect to a given digital coupon 179 by a customer.

The impression rate of a given digital coupon 179 involves the number of times that the digital coupon 179 is used in the creation of network pages 189. A higher impression rate potentially indicates a greater relevance to the creation of various network pages 189. Alternatively, a higher impression rate may indicate the overuse of a given digital coupon 179, thereby indicating that it is less desirable to include in a given network page 189.

In addition, the coupon prioritization process 126 may examine the past browse history 156 (FIG. 1) and past purchase history 159 (FIG. 1) associated with a respective customer to identify past items 136 (FIG. 1) viewed or purchased. Such items 136 may indicate the interests in the customer in making purchases. Accordingly, a digital coupon 179 may be deemed of greater interest for inclusion in a given network page 189 if it involves subject matter similar to the subject matter viewed or searched in the browse history 156 associated with a given user. Also, a given digital coupon 179 may be deemed more desirable to include in a network page 189 under construction provided that the subject matter of the digital coupon 179 is similar to the subject matter of products purchased in the past.

To this end, if the browse history 156 and/or the purchase history 159 indicate a hobby of a user, then digital coupons 179 related to such hobby would be relevant to the network page 189 under construction. For example, if a customer views and purchases tents and camping equipment, such a customer may be an outdoor enthusiast. Consequently, this indicates that digital coupons 179 relating to outdoors equipment and the like may be more desirable for inclusion in a given network page 189 to be rendered for such a customer.

Another factor involves the subject matter of the network page 189 under construction. Specifically, digital coupons 179 identified as related to the subject matter of the network page 189 may be deemed important to include in the network page 189.

In addition, the coupon usage history 163 may be examined to identify digital coupons 179 that the customer had previously redeemed that may be similar in subject matter to the digital coupons 179 under consideration. Those digital coupons 179 that may be deemed relevant to past redeemed digital coupons 179 may be included in the initial pool of relevant coupons.

Yet another factor to consider is the geographical location of the customer in situations where the customer is unknown and address information in a respective one of the customer accounts 153 is not available. In such case, the various approaches may be consulted as described in U.S. patent application entitled “Mapping Attributes to Network Addresses” filed on Jun. 29, 2007 and assigned application Ser. No. 11/771,679, which is incorporated herein by reference in its entirety. Such approaches may provide a general geographical location or other information about a customer.

In addition, there may be many other factors to consider in determining whether a given digital coupon 179 is relevant to the network page 189 under construction to the extent that it should be included in the initial pool of digital coupons 179 to be considered for presentation to the user in box 303.

Assuming that the initial pool of digital coupons 179 is identified in box 303 as mentioned above, then the coupon prioritization process 126 proceeds to box 306 in order to calculate a score for each of the digital coupons 179 included in the initial pool for purposes of determining a priority of such digital coupons 179 for presentation to the customer in the current network page 189 under construction. In order to calculate the score for each of the digital coupons 179, various approaches may be employed. In one example, an equation may be used that comprises a weighted summation of values, where each of the values is derived from any one of a number of factors as described above. For example, such a formula may be stated as follows:

Score=C₁f₁+C₂f₂+C₃f₃+ . . . +C_{N}f_{N}.

As set forth above, each factor f is weighted by a constant C that may be assigned based on experience to indicate the relative importance of each factor f in considering the score for a given digital coupon 179. Each of the factors f may comprise, for example, the affinity between respective digital coupons 179 as mentioned above. Specifically, such an affinity may comprise situations where it is determined that customers who redeem or otherwise show interest in a first digital coupon 179 also redeem or show interest in a second digital coupon 179 as described above. Another factor f may include any payment for increased exposure received from a vendor. In addition, other factors f may include conversion rates and/or impression rates as described above.

Further, other factors f to consider include the relevance of a digital coupon 179 to the subject matter of the browse history 156 of the customer, the subject matter of the purchase history 159 of the customer, or the subject matter of the coupon usage history 163 as described above. In addition, there may be other factors not described herein that may be considered in calculating a score for a respective digital coupon 179.

In order to quantify a value for each of the respective factors, one may examine the factor f relevant to other instances of a same factor for other subject matter, etc. For example, the determination may be made as to the strength of a given affinity between two digital coupons 179 based upon the number of different customers that have redeemed both digital coupons 179 relative to other such affinities identified. The greater the number of customers who have shown such an affinity relative to the average affinity experienced with other pairs of digital coupons 179, the greater the value assigned. Also, a value may be assigned with respect to the payment for increased exposure by a given vendor. Similarly, values may be assigned to respective conversion rates and impression rates relative to the average conversion rates and impression rates associated with other digital coupons 179. In addition, various algorithms may be employed to determine the relevance of a given digital coupon 179 to the subject matter of a browse history 156, purchase history 159, and/or coupon usage history 163, etc.

In addition, another factor may comprise a geographical location of a customer as determined from an IP address as described in U.S. patent application entitled “Mapping Attributes to Network Addresses” filed on Jun. 29, 2007 and assigned application Ser. No. 11/771,679, which is incorporated herein by reference in its entirety. A value may be obtained indicating the degree to which a given digital coupon 179 is relevant to a geographical location or other factor identified as described in the above-referenced patent application.

Thus, in box 306, a score is calculated for each of the digital coupons 179 identified in the initial pool of digital coupons 179 in box 303 above. Thereafter, in box 309, a list of the digital coupons 179 is sent to the requesting process such as the electronic commerce system 123 to be included in the current network page 189 under construction. In this respect, a predefined number of digital coupons 179 may be sent to the electronic commerce system 123. Such predefined number of digital coupons 179 may comprise a subset of the digital coupons 179 having the highest scores calculated in box 306.

The total number of digital coupons 179 to be sent to the electronic commerce system 123 may depend, for example, upon the number requested from the electronic commerce system 123 or based upon a standard number specified for the operation of the coupon prioritization process 126. For example, each network page 189 may only have room for a predefined number of digital coupons 179. Further, where multiple different numbers may be employed, there may be a table specified with different quantities of digital coupons 179 indicated therein for specific situations. Once the list of digital coupons 179 is sent to the requesting process of the electronic commerce system 123 in box 309, then the coupon prioritization process 126 ends as shown.

Referring next to FIG. 5, shown is a schematic block diagram of one example of a server 103 according to an embodiment of the present disclosure. The server 103 includes at least one processor circuit, for example, having a processor 403 and a memory 406, both of which are coupled to a local interface 409. To this end, the server 103 may comprise, for example, a server computer system or like device as described above. The local interface 409 may comprise, for example, a data bus with an accompanying address/control bus or other bus structure as can be appreciated.

Stored in the memory 406 are both executable applications and/or systems executed by the processor 403 and data. In particular, stored in the memory 406 and executable by the processor 403 are a server operating system 413, the electronic commerce system 123, the coupon prioritization process 126, and potentially other applications and/or systems, etc. Also, stored in the memory 406 is the data store 113 in which are stored the various data items described above so as to be accessible to the processor 403. It is understood that other data may be stored in the memory 406 and accessed by the processors 403 beyond the data described above.

A number of software components are stored in the memory 406 and are executable or executed by the processor 403. In this respect, the term “executable” means a program file that is in a form that can ultimately be run by the processor 403. Examples of executable programs may be, for example, a compiled program that can be translated into machine code in a format that can be loaded into a random access portion of the memory 406 and run by the processor 403, source code that may be expressed in proper format such as object code that is capable of being loaded into a random access portion of the memory 406 and executed by the processor 403, or source code that may be interpreted by another executable program to generate instructions in a random access portion of the memory 406 to be executed by the processor 403, etc. An executable program may be stored in any portion or component of the memory 406 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 406 is defined herein as both volatile and nonvolatile memory and data storage components. Volatile components are those that do not retain data values upon loss of power. Nonvolatile components are those that retain data upon a loss of power. Thus, the memory 406 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

In addition, the processor 403 may represent multiple processors and the memory 406 may represent multiple memories that operate in parallel. In such a case, the local interface 409 may be an appropriate network that facilitates communication between any two of the multiple processors, between any processor and any one of the memories, or between any two of the memories etc. The local interface 409 may comprise additional systems designed to coordinate this communication, including, for example, performing load balancing. The processor 403 may be of electrical or of some other available construction.

The various applications or other components described above may be implemented using any one or more of a number of programming languages such as, for example, C, C++, C#, Visual Basic, VBScript, Java, JavaScript, Perl, Ruby, Python, Flash, or other programming languages.

Although the various applications and other components such as the electronic commerce system 123 and/or the coupon prioritization process 126 described above may be embodied in software or code executed by general purpose hardware, as an alternative each may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowchart of FIG. 4 shows the functionality and operation of an implementation of the various applications and/or other components such as the coupon prioritization process 126 as described above. If embodied in software, each of the various blocks described may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flowchart of FIG. 4 shows a specific order of execution, it is understood that the order of execution may differ from that which is depicted. For example, the order of execution of two or more blocks may be scrambled relative to the order shown. Also, two or more blocks shown in succession in FIG. 4 may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, where the various applications, systems, and/or other components described herein such as the electronic commerce system 123 and/or the coupon prioritization process 126 comprise software or code, each can be embodied in any computer-readable medium for use by or in connection with an instruction execution system such as, for example, a processor in a computer system or other system. In this sense, the applications or engines may comprise, for example, statements including instructions and declarations that can be fetched from the computer-readable medium and executed by the instruction execution system. In the context of the present disclosure, a “computer-readable medium” can be any medium that can contain, store, or maintain logic or code for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A system, comprising:
a computing device;
a plurality of digital coupons in a memory associated with the computing device, the digital coupons being associated with a plurality of entities and used in association with an operation of an electronic commerce system employed to sell a plurality of items over a network; and
a process executed in the computing device that determines a subset of the digital coupons to present in a network page encoded for display on a client by the electronic commerce system by:
identifying an initial pool of the digital coupons that are relevant to a user logged into the electronic commerce system and are relevant to a subject matter of the network page;
determining a score for each of the digital coupons in the subset based on a plurality of factors by implementing a weighted summation of values, each of the values being derived from one of the factors; and
selecting a predefined number of the digital coupons having the highest ones of the scores to be included in the network page.

2. The system of claim 1, wherein one of the values represents a degree to which an affinity exists between the digital coupon and a previously redeemed one of the digital coupons by the user.

3. The system of claim 1, wherein one of the values represents a preference for a respective one of the digital coupons based on a payment by one of the entities for greater exposure.

4. The system of claim 1, wherein one of the values represents at least one of a conversion rate and an impression rate associated with a respective one of the digital coupons.

5. A method, comprising the steps of:
maintaining a plurality of coupon campaigns in a computing device for a plurality of entities in association with an operation of an electronic commerce system employed to sell a plurality of items over a network, each of the coupon campaigns comprising at least one digital coupon to be applied to a purchase of at least one of the items;
generating a network page in the electronic commerce system to be rendered on a client, the network page being generated in association with the operation of the electronic commerce system; and
determining a subset of the digital coupons to be included in the network page to present to a user.

6. The method of claim 5, wherein the step of determining the subset of the digital coupons to be included in the network page to present to the user further comprises the step of identifying an affinity between a first one of the digital coupons and a second one of the digital coupons, where the user has previously redeemed the first one of the coupons.

7. The method of claim 6, wherein the affinity is determined by identifying a predefined percentage of customers that redeemed the first one of the digital coupons that also redeemed the second one of the coupons.

8. The method of claim 5, wherein the step of determining the subset of the digital coupons to be included in the network page to present to the user further comprises the step of identifying at least one of the digital coupons having a highest rate of redemption relative to at least a subset of other ones of the digital coupons.

9. The method of claim 5, further comprising the steps of:
identifying a pool of the digital coupons based upon a demographic to which a user belongs;
determining a score for each of the digital coupons in the subset based on a plurality of factors; and
selecting a predefined number of the digital coupons having the highest ones of the scores to be included in the network page.

10. The method of claim 9, wherein one of the factors considered in determining the score comprises an affinity between the digital coupon and a previously redeemed one of the digital coupons by the user.

11. The method of claim 9, wherein one of the factors considered in determining the score comprises a preference for a respective one of the digital coupons based on a payment by one of the entities for greater exposure.

12. The method of claim 9, wherein one of the factors considered in determining the score comprises a conversion rate associated with a respective one of the digital coupons.

13. The method of claim 9, wherein one of the factors considered in determining the score comprises an impression rate associated with a respective one of the digital coupons.

14. A system, comprising:
a computing device;
a plurality of digital coupons in a memory associated with the computing device, the digital coupons being associated with a plurality of entities and used in association with an operation of an electronic commerce system employed to sell a plurality of items over a network; and
a process executed in the computing device that determines a subset of the digital coupons to present in a network page encoded for display on a client by the electronic commerce system.

15. The system of claim 14, wherein at least one of the entities comprises a vendor that sells the items to a merchant that operates the electronic commerce system.

16. The system of claim 14, wherein at least one of the entities comprises a merchant that operates the electronic commerce system.

17. The system of claim 14, wherein the process is configured to determine the subset of the digital coupons to present in the network page by identifying an affinity between a first one of the digital coupons and a second one of the digital coupons, where a user identified by the electronic commerce system has previously redeemed the first one of the coupons.

18. The system of claim 17, wherein the process is configured to determine the subset of digital coupons to present in the network page by identifying whether a predefined percentage of customers that redeemed the first one of the digital coupons had also redeemed the second one of the coupons.

19. The system of claim 14, wherein the process is configured to determine the subset of digital coupons to present in the network page by identifying at least one of the digital coupons having a rate of redemption above a predefined threshold.

20. The system of claim 14, wherein the process is configured to determine the subset of digital coupons to present in the network page by:
identifying an initial pool of the digital coupons;
determining a score for each of the digital coupons in the subset based on a plurality of factors; and
selecting a predefined number of the digital coupons having the highest ones of the scores to be included in the network page.

21. The system of claim 20, wherein the digital coupons are included in the initial pool if relevant to a user logged into the electronic commerce system.

22. The system of claim 20, wherein the digital coupons are included in the initial pool if relevant to a subject matter of the network page.

23. The system of claim 20, wherein the process determines the score for each of the digital coupons in the subset based on the plurality of factors by implementing a weighted summation of values, each of the values being derived from one of the factors.

24. The system of claim 23, wherein one of the values represents a degree to which an affinity exists between the digital coupon and a previously redeemed one of the digital coupons by a user.

25. The system of claim 23, wherein one of the values represents a preference for a respective one of the digital coupons based on a payment by one of the entities for greater exposure.

26. The system of claim 23, wherein one of the values represents a conversion rate associated with a respective one of the digital coupons.

27. The system of claim 23, wherein one of the values represents an impression rate associated with a respective one of the digital coupons.
